(19) United States
(12) Patent Application Publication
(10) Pub. No.: US 2010/0012490 A1
(43) Pub. Date: Jan. 21, 2010

(54) TEST STRIP WITH OPTICAL IDENTIFICATION PATTERNS AND TEST INSTRUMENT USING THE SAME

(76) Inventor: Tien-Tsai Hsu, Hsinchu (TW)

Correspondence Address: SINORICA, LLC, 2275 Research Blvd., Suite 500, ROCKVILLE, MD, 20850, US

(21) Appl. No.: 12/173,258

(22) Filed: Jul. 15, 2008

(51) Int. Cl. G01N 27/26; G01N 21/01; G01N 21/78

(52) U.S. Cl. 204/400; 422/82.05; 422/55

(57) ABSTRACT

The present invention discloses a test strip with optical identification patterns and a test instrument using the same characterized in that the test strip incorporates an identification area. Different combinations of optical identification patterns on the identification area create different digital identification signals. After the test strip is inserted into the test instrument, the test instrument will obtain the digital identification signal and learn the test code, analysis parameters, expiry date and batch number of the test strip. Thereby, the test instrument can verify the batch number and expiry date of the test strip, perform calibration according to the analysis parameters, and provide a correct test result. The present invention can provide many sets of digital identification signals to differentiate test strips. Therefore, the present invention can be operated fast, conveniently and correctly and can prevent a user from forgetting to calibrate the test instrument.

### BACKGROUND OF THE INVENTION

1. Field of the Invention

The present invention relates to a test strip and a test instrument using the same, particularly to a test strip with optical identification patterns and a test instrument using the same.

2. Description of the Related Art

With the development of bio-test technologies, many tests can be undertaken in a clinic or even by a patient at home. Those tests, such as biochemical tests, immunological tests, gene tests, etc., are originally performed by specialists, like physicians, medical technologists or researchers, in special sites, like hospitals or laboratories, with precision equipments. Such a technology is called POCT (Point of Care Test). Common biochemical POCT tests include tests of glucose, cholesterol, uric acid, etc. Common immunological POCT tests include tests of pregnancy, drugs, tumor markers, glycated hemoglobin, enterovirus gene, etc. POCT technologies and their derivatives can apply not only to medical and biochemical fields but also to veterinary, agricultural, industrial and environment-protection fields.

POCT can provide fast and convenient tests. POCT can only provide qualitative tests before, but it has been able to perform quantitative tests now. In accuracy, POCT has been improved from an error rate of 20% to 15% or even below 10%. Various POCT test instruments have been developed, such as glucose meters, cholesterol meters, drug testers, enterovirus testers, etc.

In principle, a sample is dripped on a test area or suction area of a POCT test strip; then, the tested object reacts with a reagent in the test area or suction area; the reaction causes a change of an optical or electrical property; and the test instrument detects and calculates the change to obtain the concentration of the tested object.

Refer to FIG. 1 for a conventional optical test strip, wherein a substrate 10 has an optical test area 11; the tested object reacts with a reagent in the optical test area 11; then the test instrument detects and calculates an optical property change to obtain the concentration of the tested object.

Refer to FIG. 2 for a conventional electrochemical test strip, wherein a substrate 10 has an electrochemical test area 12, which is connected with a working electrode 13 and a counter electrode 14 separated from the working electrode 13; the tested object reacts with a reagent in the electrochemical test area 12; the signal of the electricity change is transmitted to the test instrument via the electrodes; then the test instrument receives and calculates the signal to obtain the concentration of the tested object.

Refer to FIG. 3 for a conventional immunological test strip, wherein a substrate is arranged inside a casing 15; a sample is dripped into a suction area 16, the tested object in the sample reacts with a regent in the suction area 16; an appropriate solvent is dripped into the suction area 16 and carries the reacted tested object to a color reaction/colorimetric area 17 via a capillary effect; then the test instrument receives and calculates the signal to obtain the concentration of the tested object.

For obtaining correct test results, related analysis parameters have to be calibrated in the abovementioned quantitative test instruments according to the characteristics of the adopted test strip and reagent. In some cases, even the production data, quality control data, expiry date, etc., are required to input into the test instrument.

The analysis parameters are generally input into the memory of the test instrument via a keying method. However, such a method is too complicated and impractical for a POCT user, who is not necessarily familiar with such a method.

Two U.S. Pat. No. 5,053,119 and U.S. Pat. No. 5,366,609 utilize an EEPROM (Electrically Erasable Programmable Read Only Memory), which is also called a code card, to input analysis parameters into the memory of a test instrument, and calibration is thus simplified. However, some users may still forget to insert the attached code card into the test instrument when they use a new batch of test strips or reagent. For POCT users, such a scheme cannot guarantee correct test results yet.

In a U.S. Pat. No. 6,814,844, the batch number and expiry date in the bar-code form are printed on test strips and input into a test instrument via a bar-code reader. The analysis parameter of the test strips are printed on a blank test strip in the form of bar code, and the parameter-containing test strip functions as a parameter-setting test strip. Before using a new batch of test strips, the attached parameter-setting test strip is inserted into a test instrument to set the analysis parameters. The conventional technology is distinct from the abovementioned U.S. Pat. No. 5,053,119 and U.S. Pat. No. 5,366,609. However, a parameter-setting procedure is still needed, and a user may still forget to calibrate the test instrument.

To reduce the probability of forgetting to calibrate the instrument, many schemes have been proposed, and the products thereof have been sold in the marketplace. For example,

An analyzer with a bar-code scanning function: The bar-code is printed on the surface of the test strips or the package of the reagent. The analyzer can automatically read the bar-code, and the parameters are thus automatically set. Although the scheme can effectively solve the abovementioned problem, the device has a bulky size and a higher price.

A disposable analyzer: The analyzer has built-in parameters of the test strips or reagent. When the test strips or reagent are used up, the analyzer is also abandoned. Such a scheme can free users from setting parameters. However, it wastes resources, causes an environmental problem and has a high price.

An analyzer with a unique set of parameters: Such a scheme also free users from setting parameters but has a greater error range and a higher production defective fraction.

From those discussed above, it is known that calibration-free is an important and necessary feature of a POCT analyzer. Although many products to solve the problem have been proposed and sold in the marketplace, all of them still have room to improve. Accordingly, the present invention proposes a test strip with identification openings and a test instrument using the same to overcome the conventional problems.

### SUMMARY OF THE INVENTION

One objective of the present invention is to provide a test strip with optical identification patterns and a test instrument using the same, wherein a test strip incorporates an identification area having optical identification patterns, and a test instrument has a detector able to read optical identification patterns contained in the test strip and generate related digital identification signals, whereby the analysis parameters, expiry date, batch number, etc. of the test strip are automatically transmitted to the test instrument, and the test instrument is then automatically calibrated. Thus, the present invention can effectively prevent a user from forgetting to calibrate a POCT analyzer.

To achieve the abovementioned objective, the present invention form optical identification patterns on an identification area of a test strip according to the characteristics of the test strip, and the optical identification patterns will create related digital identification signals. The present invention also proposes a test instrument to cooperate with the test strip. After receiving the digital identification signals, the test instrument can determine the parameter-setting data and product data of the test strip. Thereby, the test instrument can fast and correctly set the analysis parameters of a test strip.

Another embodiment of the present invention comprises an optical identification area formed on a casing of a test strip according to the characteristics of the test strip, and the identification area has optical identification patterns to create a digital identification signal. Below, the embodiments are described in detail in cooperation with the attached drawings to make easily understood the objectives, technical contents, characteristics and accomplishments of the present invention

### DESCRIPTION OF THE DRAWINGS

FIG. 1 is a top view of a conventional optical test strip;

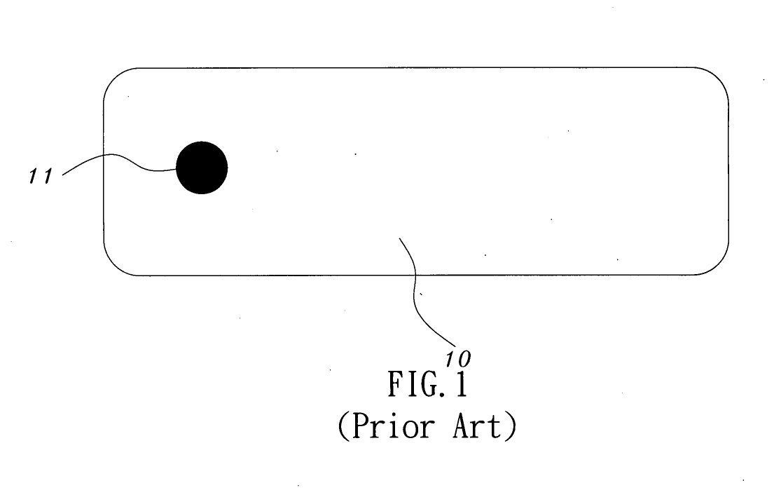

FIG. 2 is a top view of a conventional electrochemical test strip;

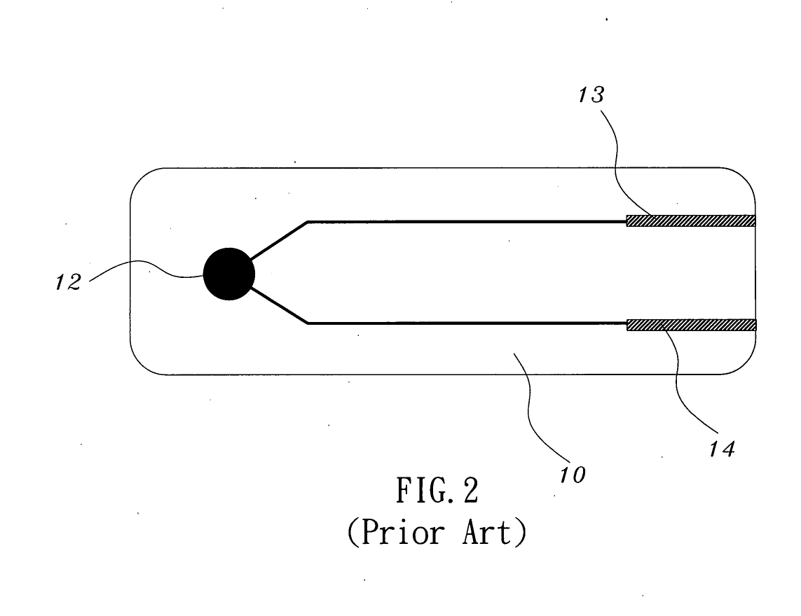

FIG. 3 is a perspective view of a conventional immunological test strip;

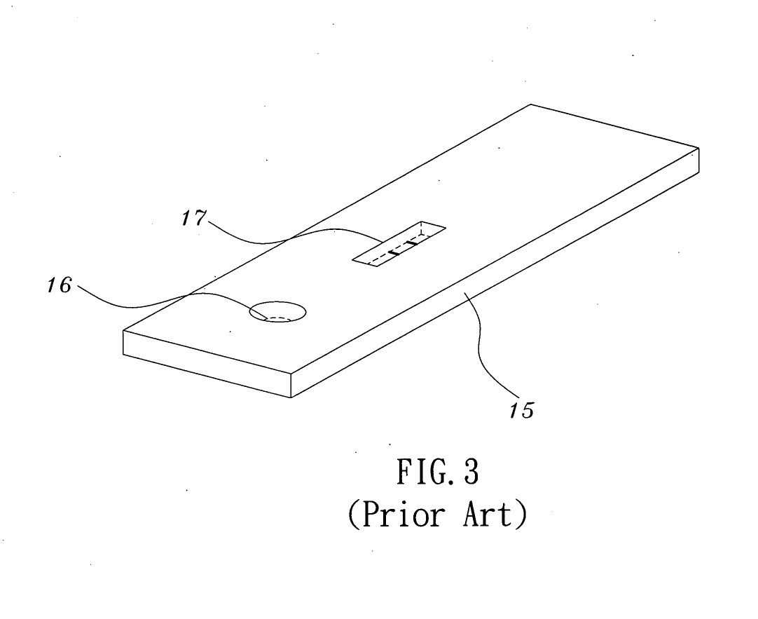

FIG. 4 is a top view of a test strip according to a first embodiment of the present invention;

FIG. 5 is a top view of a test strip according to a second embodiment of the present invention;

FIG. 6 is a perspective view of a test strip according to a third embodiment of the present invention; and

FIG. 7 is a diagram schematically showing a test instrument according to the present invention.

### DETAILED DESCRIPTION OF THE INVENTION

The present invention proposes a test strip with optical identification patterns and a test instrument using the same, which applies to various POCT analysis devices, such as blood glucose meters, cholesterol meters, and immunological analyzers. The test strip of the present invention is characterized in having a test area and an identification area. The test area is an optical test area, an electrochemical test area, or a color reaction/colorimetric area. The identification area has optical identification patterns, and the test instrument can obtain the digital identification signals from a detector, which is corresponding to the type of optical identification patterns.

The test strip of the present invention includes three embodiments, and the test strip of each of the three embodiments has an identification area containing optical identification patterns. Among them, a first embodiment involves an optical test area; a second embodiment involves an electrochemical test area coupled to two separated electrodes, which transfer to the test instrument the current variation generated by the electrochemical reaction in the test area; a third embodiment involves a color reaction/colorimetric area, wherein the substrate is packaged inside a casing, but the identification area is arranged on the casing. Below are described in detail the technical contents of the three embodiments.

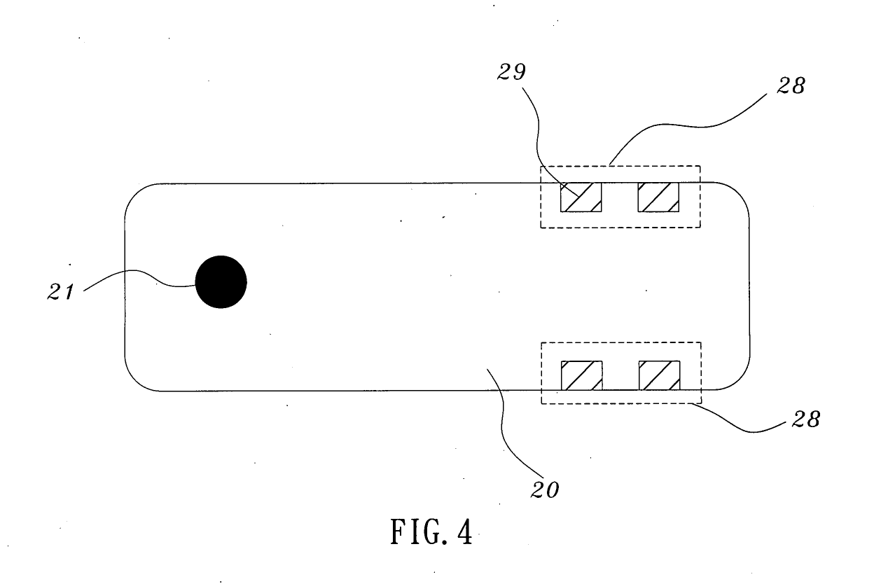

Refer to FIG. 4 for the first test strip embodiment of the present invention, wherein an optical test strip has an optical test area 21 and an optical identification area 28 on a substrate 20. The optical identification area 28 has optical identification patterns 29, which is monochromatic or chromatic. After the fabrication and examination of the test strip is completed, the optical identification patterns 29 are formed on the optical identification area 28 with such as an laminating method, a printing method, or a laser method. As shown in FIG. 4, the optical identification area 28 has four optical identification patterns 29, which represents a digital identification signal. The combinations of different optical identification patterns 29 on the optical identification area 28, including blank optical identification patterns 29, can represent different sets of digital identification signals each containing a test code, analysis parameters, an expiry date or a batch number.

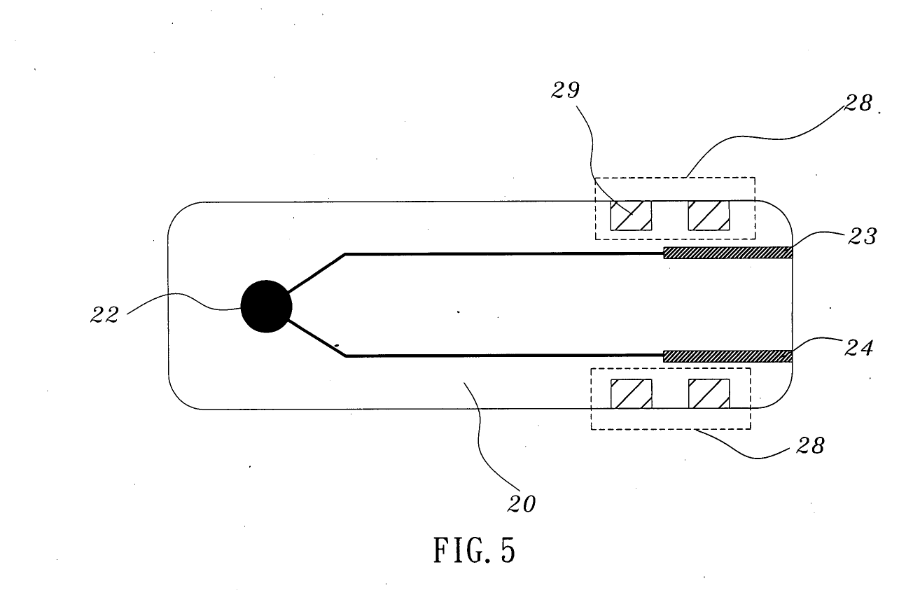

Refer to FIG. 5 for the second test strip embodiment of the present invention, wherein an electrochemical test strip has an electrochemical test area 22 and an optical identification area 28 on a substrate 20. The optical identification area 28 has optical identification patterns 29. The electrochemical test area 22 is connected with a working electrode 23 and a counter electrode 24, which transfer to the test instrument the current variation generated by the electrochemical reaction in the electrochemical test area 22. The optical identification area 28 of the second embodiment is similar to that of the first embodiment and will not repeat herein.

Furthermore, in the abovementioned two test strip embodiments, the substrate is arranged inside a casing (not shown), and the casing has at least two windows to expose the test area and the identification area on the substrate.

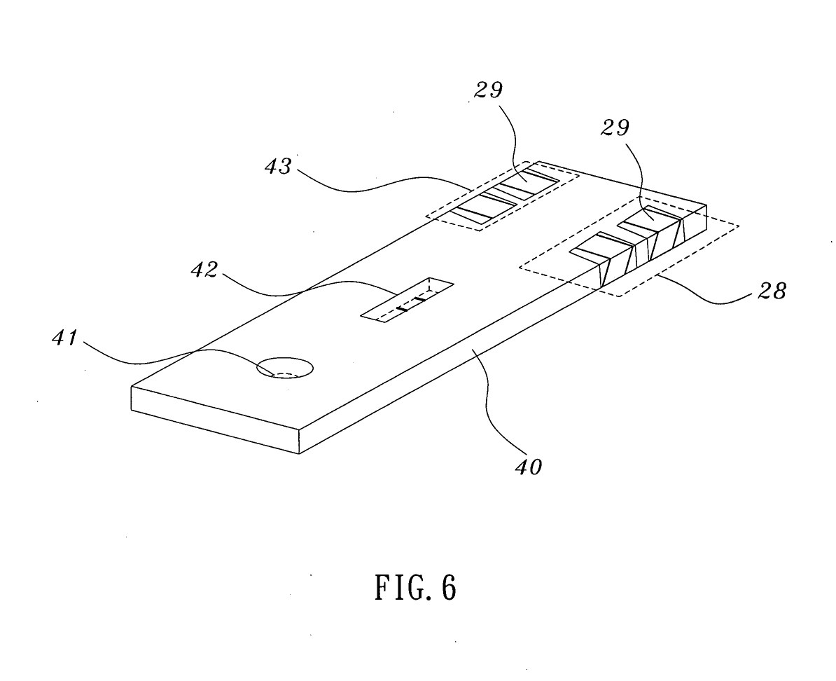

Refer to FIG. 6 for the third test strip embodiment of the present invention, wherein the substrate (not shown in the drawings) is arranged inside a casing 40, and the casing 40 has at least two windows to expose a suction area 41 and a color reaction/colorimetric area 42. The casing also has an optical identification area 28, in other words, the optical identification area 28 is formed on the casing to create a digital identification signal The optical identification area 28 has optical identification patterns 29, which is monochromatic or chromatic. After the fabrication and examination of the test strip is completed, the optical identification patterns 29 are formed on the optical identification area 28 of the casing with such as an laminating method, a printing method, or a laser method. As shown in FIG. 6, the optical identification area 28 has four optical identification patterns 29, which represents a digital identification signal. The combinations of different optical identification patterns 29 on the optical identification area 28, including blank optical identification patterns 29, can represent different sets of digital identification signals each containing a test code, analysis parameters, an expiry date or a batch number.

Further, the optical identification area on the casing of the third test strip embodiment may be used in the abovementioned test strip with the electrochemical test area or the optical test area. The substrate is arranged inside the casing, and the casing 40 has the optical identification area and at least one window to expose the electrochemical test area or the optical test area.

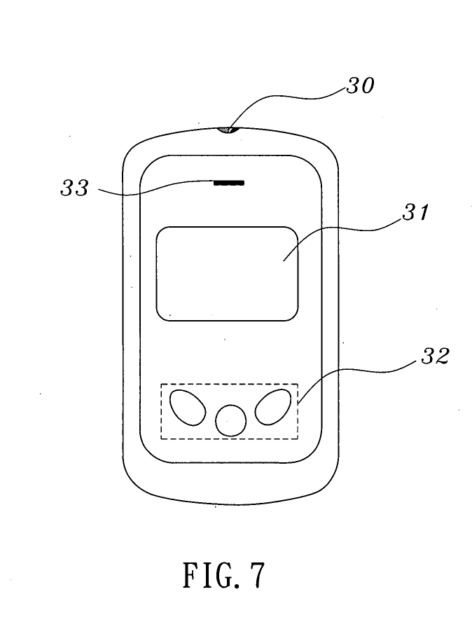

Refer to FIG. 7 a diagram schematically showing a test instrument according to the present invention. The test instrument of the present invention comprises: a test port 30, a display 31, control buttons 32, and a detector 33. The test port 30 is an opening where a test strip is inserted. The detector 33 is arranged inside the test instrument and may be an optoelectronic connector. When the identification-area side of the test strip is inserted into the test port 30, the optical identification area is at a position corresponding to the detector 33. The detector 33 detects the digital identification signals of the test strip and obtains the information of the related test code, analysis parameters, expiry date, and batch number. The test instrument also has a microprocessor (not shown in the drawings) used to analyze test data. As the microprocessor is not the feature of the present invention but a conventional device, the technical contents thereof will not be described herein.

In all the three abovementioned embodiments, the test instrument needs a detector of an optoelectronic connector, which senses the light passing through the optical identification area of a test strip and generates a digital identification signal for the test instrument. The digital identification signal carrying the information of the analysis parameters, expiry date and batch number of the test strip is automatically transmitted to the test instrument, and then the test instrument is automatically calibrated. Thereby, the present invention can effectively prevent a user from forgetting to calibrate a POCT analyzer.

Any of the abovementioned embodiments can cooperate with resistor elements to provide more sets of identification signals to satisfy the requirements of different customers, different test instruments and different test strips. To speak in detail, a resistance identification area (not shown in the drawings) may be formed on the test strip of the present invention, wherein the resistance identification area has a resistor element coupled to an electrode area to generate an analog identification signal. If the test area of the test strip is the abovementioned electrochemical test area, the electrode area has a working electrode and a counter electrode, and the working electrode and the counter electrode are coupled to the electrochemical test area and the resistor element. If the test area of the test strip is the abovementioned optical test area or color reaction/colorimetric area, the electrode area has a ground electrode and a power signal cable, and the ground electrode and the power signal cable is coupled the resistor element. Thereby, the combination of the optical identification area and the resistance identification area of the test strip can provide more identification signals.

The embodiments described above are to demonstrate the technical contents and characteristics of the present invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A test strip with optical identification patterns comprising
a substrate;
a test area formed on said substrate; and
an identification area formed on said substrate and having at least one optical identification pattern to create a digital identification signal.

2. The test strip with optical identification patterns according to claim 1, wherein said test area is an electrochemical test area or an optical test area.

3. The test strip with optical identification patterns according to claim 1, wherein said digital identification signal represents a test code, analysis parameters, an expiry date or a batch number.

4. The test strip with optical identification patterns according to claim 1, wherein said optical identification pattern is formed on said substrate with an laminating method, a printing method, or a laser method.

5. The test strip with optical identification patterns according to claim 1, wherein said optical identification pattern is monochromatic or chromatic.

6. The test strip with optical identification patterns according to claim 1 further comprising a casing encasing said substrate thereinside.

7. The test strip with optical identification patterns according to claim 6, wherein said test area is a color reaction/colorimetric area.

8. The test strip with optical identification patterns according to claim 2 further comprising a resistance identification area, wherein said resistance identification area has at least one resistor element coupled to an electrode area to generate an analog identification signal, and wherein if said test area is said electrochemical test area, said electrode area has a working electrode and a counter electrode, and said working electrode and said counter electrode are coupled to said electrochemical test area and said resistor element.

9. The test strip with optical identification patterns according to claim 2 further comprising a resistance identification area, wherein said resistance identification area has at least one resistor element coupled to an electrode area to generate an analog identification signal, and wherein if said test area is said optical test area, said electrode area has a ground electrode and a power signal cable, and said ground electrode and said power signal cable are coupled to said resistor element.

10. The test strip with optical identification patterns according to claim 7 further comprising a resistance identification area, wherein said resistance identification area has at least one resistor element coupled to an electrode area to generate an analog identification signal, and said electrode area has a ground electrode and a power signal cable, and said ground electrode and said power signal cable are coupled to said resistor element.

11. A test strip with optical identification patterns comprising:
a substrate;
a test area formed on said substrate;
a casing encapsulating said substrate; and
an identification area formed on said casing and having at least one optical identification pattern to create a digital identification signal.

12. The test strip with optical identification patterns according to claim 11, wherein said test area is an electrochemical test area, an optical test area or a color reaction/colorimetric area.

13. The test strip with optical identification patterns according to claim 11, wherein said digital identification signal represents a test code, analysis parameters, an expiry date or a batch number.

14. The test strip with optical identification patterns according to claim 11, wherein said optical identification pattern is formed on said casing with a laminating method, a printing method, or a laser method.

15. The test strip with optical identification patterns according to claim 11, wherein said optical identification pattern is monochromatic or chromatic.

16. A test instrument, cooperating with a test strip to perform a test, and comprising a test port and a detector arranged inside said test port, wherein an identification area of a test strip inserted into said test port is at a position corresponding to said detector, and said detector generates a digital identification signal according to optical identification patterns on said identification area.

17. The test instrument according to claim 16, wherein said detector is an optoelectronic connector.
